(19) United States
(12) Patent Application Publication
(10) Pub. No.: US 2026/0369018 A1
(43) Pub. Date: Nov. 19, 2026

(54) METHODS OF RENDERED 360-DEGREE 3-DIMENSIONAL DIGITAL TRYON FROM A SINGLE IMAGE OF A HUMAN SUBJECT WEARING AN ARTICLE OF CLOTHING

(71) Applicant: Topsymart LLC, Middletown, DE (US)

(72) Inventor: Krishnendu Roy, South Plainfield, NJ (US)

(21) Appl. No.: 19/206,925

(22) Filed: May 13, 2025

(51) Int. Cl. G06T 19/20

(52) U.S. Cl. CPC G06T 19/20; G06T 2210/16; G06T 2219/2016

(57) ABSTRACT

The disclosure provides a method of rendering an image on a computer display, of a subject wearing an article of clothing including providing or selecting an image of a first article of clothing on the computer; providing an image on the computer of the subject wearing one or more articles of clothing that do not include the first article of clothing, inputting the image of the first article of clothing and the provided image of the subject wearing the one or more articles of clothing to an artificial intelligence (AI) transfer engine, outputting from the artificial intelligence transfer engine a 2 dimensional (2D) image of the person wearing the second article of clothing, inputting the two-dimensional image of the subject wearing the second article of clothing into a 360 degree 3 dimensional (3D) view engine, outputting the subject wearing the second article of clothing in 3D.

### BACKGROUND

### Technical Field of the Invention

The technical field of the invention relates to a feature agnostic fashion 3 dimensional digital try on application from a monocular single image of a person.

### Description of the Related Art

Online clothing returns significantly impact the environment through increased transportation emissions, packaging waste, and the potential for discarded items. Returning items requires extra shipping, generating more carbon emissions from trucks and planes. Returns often involve extra packaging materials like boxes, plastic wraps, and tape, adding to the overall waste stream. Many returned items are deemed unsellable due to damage, seasonality, or the cost of handling, and end up in landfills. The process of handling returns (cleaning, re-packaging, or repairing) also increases energy consumption. The rise of fast fashion contributes to higher return rates, exacerbating the environmental impact.

Two of the top reasons for customer dissatisfaction are high return rates in fashion E-commerce and demand for personalized customer experiences. According to industry data, online fashion retailers experience returns rates of up to 30%-40%. A large proportion of these returns are attributed to mismatched sizing and visual expectations. Modern online shoppers also seek a personalized, interactive experiences that replicate (or even surpass) the benefits of in-store shopping.

Accordingly, there is a need for an application that will empower customers to visualize how garments will fit and look on their own bodies before making a purchase. This would significantly reduce returns and enhance overall customer satisfaction.

### SUMMARY DISCLOSURE OF THE INVENTION

This disclosure provides a method of rendering an image on a computer display of a subject wearing an article of clothing including the steps of providing or selecting an image of an article of clothing on the computer, providing an image on the computer of the subject wearing one or more articles of clothing which are not the same as the aforementioned article of clothing, inputting the image of the first article of clothing and the provided image of the subject wearing one or more articles of clothing to an artificial intelligence (AI) transfer engine, outputting from the artificial intelligence transfer engine a 2 dimensional (2D) image of the person wearing the first article of clothing, inputting the two-dimensional image of the subject wearing the first article of clothing into a 360 degree 3 dimensional (3D) view engine, outputting from the 360 degree 3 dimensional (3D) view engine a 360 degree 3 dimensional view of the subject wearing the first article of clothing.

This disclosure is thus directed to a first in kind AI-based application for the e-commerce fashion industry to help an end user or customer. Just a click of single Person Customer Image will be enough to achieve virtual clothes fitting, no need for multi directional images or 3D body scan. Visualize how garments will fit and look on their own bodies with a 360 Degree 3D View before making a purchase, significantly reducing returns and enhancing overall customer satisfaction.

Only One Single Person Customer Image is needed to achieve virtual fitting, no need for multi directional images or 3D body scan. A Customer provided body measurement is not needed which makes it intuitive and frictionless use by a Customer. The disclosed app uses innovative AI Pipeline, and it follows Responsible AI methodology to protect customer data. The application can be used as a widget to any online marketplace.

Other features and aspects will be apparent from the following detailed description, the drawings, and the claims.

### BRIEF DESCRIPTION OF THE DRAWINGS

FIG. 1 shows a flow chart illustrating an embodiment of the invention.

FIG. 2 and FIG. 2 (Cont.) show an exemplary process of the Disclosure.

FIG. 3 and FIG. 3 (Cont.) show another exemplary process of the disclosure.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DISCLOSURE OF THE INVENTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

### MODES FOR CARRYING OUT THE INVENTION

This simple to use Invention is an AI based App which provides a 3D 360-degree view of a customer for any cloth: upper body, lower body or dresses selected by the customer on any online clothing platform. Provides size fit and visual confirmation by customer. Requires no data retention on server. Provides auto fit for the clothes on the customer with system recommended size. In embodiments, the customer uploads a single image, no full body scan required.

The input includes uploading a photo of a person wearing some clothing. The same person then selects a separate clothing image. A synthesized image of the same person, in the same pose, now wearing the target item is then produced. A 360-degree 3D View of the person wearing the clothing is subsequently produced.

Embodiments of the methodology of the Transfer Engine are described below.

Initialization: This loads the base components (UNet, VAE, Scheduler, optional Safety Checker). Apply attention modules to the UNet. Input Preparation: Ensures all images/masks match the desired resolution. Resizes and pads as needed. Converts them into tensors.

Masking & Encoding: Creates a “masked image” by applying the mask. Passes images through the VAE encoder to obtain latent representations for the masked image, condition image, and mask itself.

Concatenate Conditional, Masked Latent Space Variables with Random Noise: Combines masked image Latent Space Variables and condition Latent Space Variables along the designated dimension. Creates initial random noise matching the shape of the Latent Space Variables.

Denoising Loop: Sets up the DDIM (Denoising Diffusion Implicit Models) or similar scheduler timesteps. Optionally duplicates Latent Space Variables for classifier-free guidance (CFG). Iterates through each timestep, predicting noise with the UNet, combining Conditional/Unconditional predictions if CFG is used, and stepping the scheduler.

Decoding and Safety Checking: Splits the final Latent Space Variables (in case CFG was used). Passes them into the VAE decoder to produce the final images. Optionally runs a safety checker.

Intermediate 2D Image with new cloth on: Returns the processed PIL image to the User. Pass this image as input to 360 Degree View Engine

Embodiments of the methodology of the 360 Degree View Engine as follows.

360 Degree View Engine: Geometry Sculpting with a 3D-Aware Diffusion Prior. Utilizes Score distillation sampling (SDS) on random novel views for coarse geometric alignment. Incorporates a Viewpoint-Conditioned Diffusion model as a “3D prior” that enforces multi-view consistency better than a plain 2D diffusion model. This mitigates problems like the Janus issue and other geometry artifacts. Uses Rotating View Training (gradually expanding the range of camera viewpoints) and starting with higher-noise diffusion steps, then refining with lower noise) to stabilize geometry. Switches from an implicit surface representation (NeuS neural surface reconstruction method) for coarse geometry to a mesh-based representation (DMTet, Deep Marching Tetrahedra) for more fine-grained, high-resolution detail.

Augmented Texture: Optimized SDS for sharper and more realistic texture. Proposes fine-tuned diffusion model (via Stable Diffusion) on multi-view renderings of the current 3D scene. Based on trained model studies a Gaussian Distribution (and Gradient Descent) was observed if Texture Resemblance plotted against Epoch, the realistic view of the textured face reaches a peak in Gaussian Curve as the scene improves, newly rendered images further finetune the model; in turn, the improved diffusion model yields better texture guidance. The most optimized value of the epoch as final and fast limit of the optimization is selected. This repetitive optimization gradually increases both texture fidelity and cross-view consistency.

Impose 3D Consistency Hints: Leverages single-view depth/normal estimations to guide geometry at the reference viewpoint. Imposes photometric loss and profile outline constraint at the reference view to align the 3D model with the initial 2D image.

Final Result for 360 Degree 3D View is obtained by combining (1) a robust geometry-sculpting strategy that uses both a 2D diffusion prior and a 3D-aware diffusion prior, and (2) a texture-augmenting stage that self-improves us achieve realistic 3D assets than previous single-image 3D-generation methods.

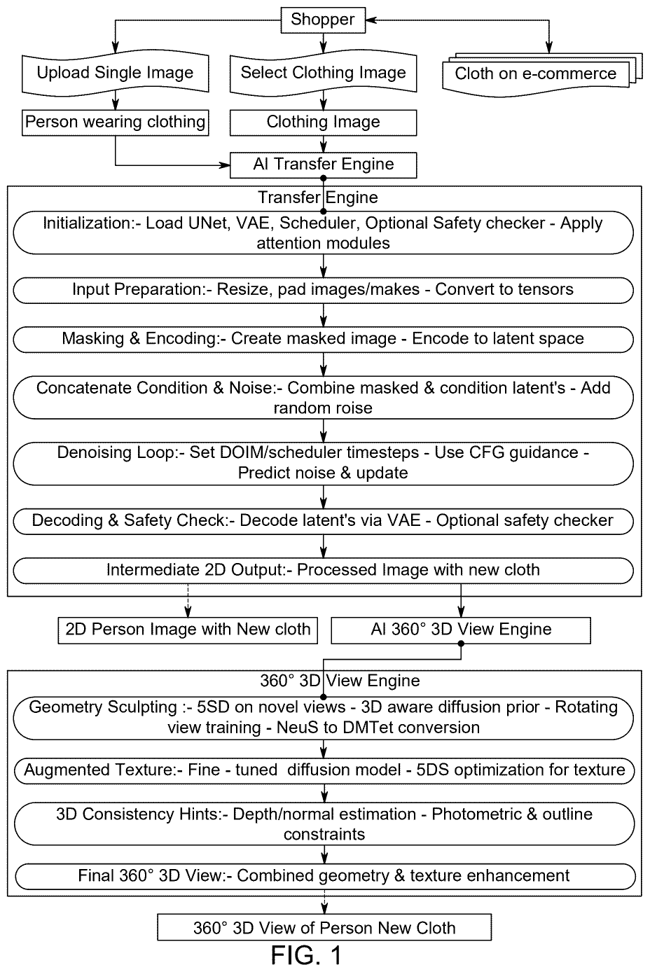

FIG. 1 shows a flow chart of an embodiment of the disclosed methods. In FIG. 1, a subject uploads a single image of a person wearing clothing and selects a clothing image, for example, from a cloth on an e-commerce platform. The image of the person wearing clothing and the clothing image are then input to the AI transfer engine. The AI transfer engine may then perform steps including: initialization; input preparation; Masking and encoding; concatenate condition and noise; a denoising loop; decoding and safety check; and intermediate 2D output. Thus, the AI transfer engine produces a 2D image of the person with the new cloth.

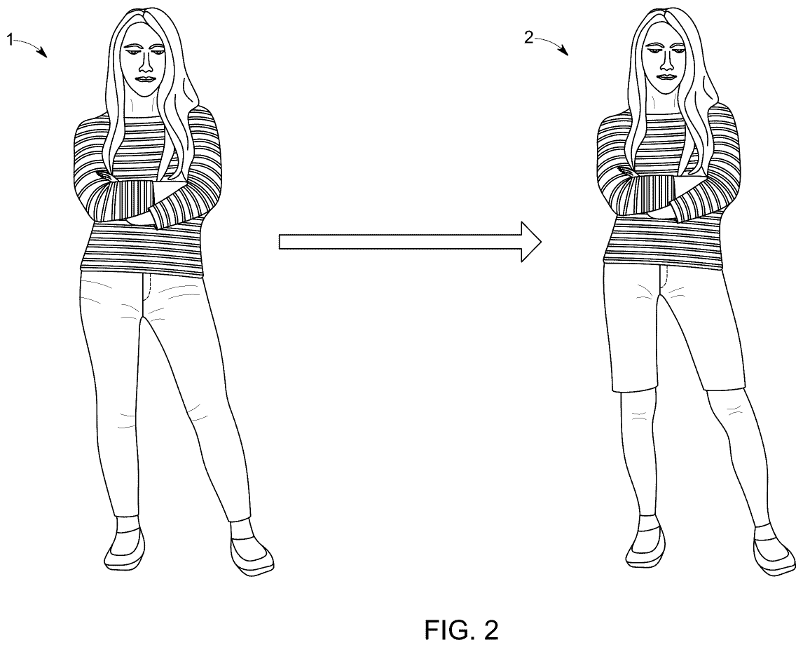

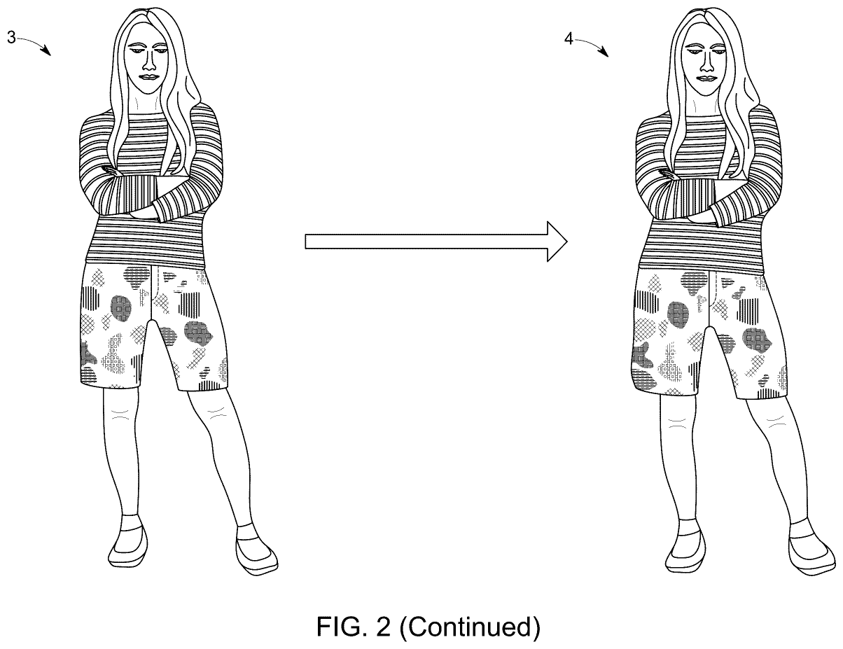

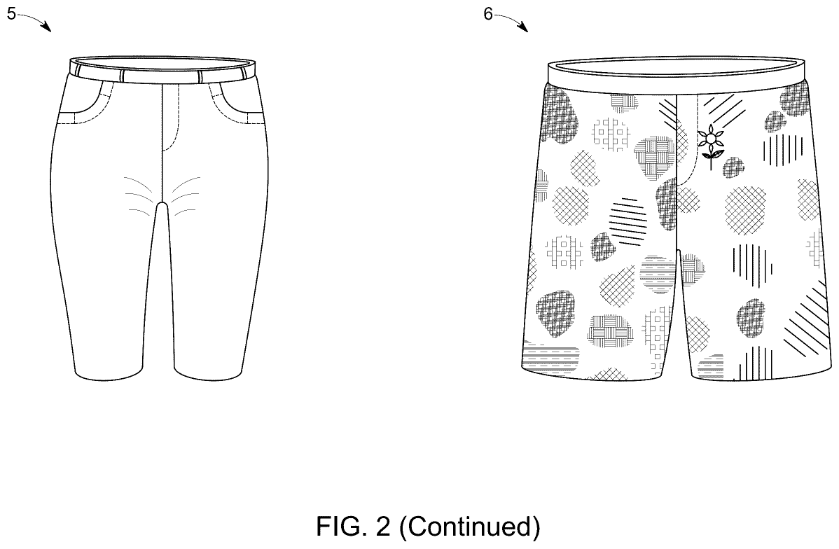

FIG. 2 shows a model at various stages of the process. Model 1 shows an image of the model uploaded onto a computer wearing some clothing. Images of clothes 5, 6 are shown in FIG. 2 (Cont.), in this case shorts, size M, and represent images of articles of clothing obtained, for example, from an e-commerce site. Model 2 shows the model wearing the pair of shorts 5 obtained from an ecommerce site. Model 3 shows the model wearing another article of clothing, shorts 6, obtained from an ecommerce site. Model 4 is a final output image, a 3D image (not illustrated), of the model wearing shorts 6.

The AI transfer engine 2D output can then be transferred to an AI 360 degree 3D view engine. The AI 360 degree 3D view engine can then perform steps including: geometry sculpting; augmented texture; 3D consistency hints; and final 360 degree 3D view. Accordingly, the AI 360 degree 3D view engine outputs a 360 degree 3D view of the person wearing the new cloth.

As described further below, the invention can be implemented in a computer program product tangibly embodied in a machine-readable storage device and/or memory for execution by a programmable processor. The described methods can thus generally be implemented as an app which so refers to a software platform, as described above, that can run on a mobile device, a notebook or laptop computer, a desktop computer, or other home or business computer.

Transfer Engine Training Strategy: The engine performs diffusion rectification and estimation enhancement. The approach leveraged Latent Diffusion Model (LDM) framework (Rombach et al., 2021) to have better noise management strategy. The predicted noise (ϵ_{θ}) is mixed with the prior noise (ϵ) with weightage value λ, as described by the equation

zₜ=\sqrt{αₜ}z₀+\sqrt{(1−αₜ)}(ε+λε_{θ})

L_{D}=E_{x,ε~N(0,1),t}∥ε−ε_{θ}(zₜ,t)∥²
x∈R^{3×H×W}: input image
t∈{1, . . . , T}: diffusion timestep
β₁, . . . , β_{T}∈(0,1): noise scheduler

$$- {α}_{t} = {\prod }_{i = 1}^{t} ( 1 - {β}_{i} )$$

ε~N(0,1): standard Gaussian noise
zₜ=\sqrt{αₜ}x+\sqrt{(1−αₜ)}ε: noisy latent
ε_{θ}(⋅, t): UNet noise predictor
   Rather than updating the full UNet, this invention concludes only the self-attention layers (49.57 M parameters) is enough to adapt pretrained LDM to use without any loss, preserving the model's prior and drastically reducing training cost. Three variants were compared:

| Trainable Modules | Parameters (M) |
|---|---|
| Full UNet | 915.63 |
| Transformer Blocks | 352.23 |
| Self Attention Only | 58.71 |

Transfer Engine Network is subdivided into the following:
1. VAE Encoder/Decoder (ε, D): maps images to and from the 4-channel latent space Encoder ε: R^{3×H×W}→R^{4×(H/8)×(W/8)} and Decoder D: R^{4×(H/8)×(W/8)}→R^{3×H×W} R denotes the set of real numbers
   (R^{C×H×W}) is the space of real valued matrices with (C) number Channels (H) rows of heights and (W) columns of widths.
2. Simplified Denoising UNet: A standard LDM UNet with all cross attention modules removed and only self-attention layers left trainable. At inference, person image and garment reference are each encoded by ε, then concatenated along the spatial dimension before denoising

Transfer Engine Inference has the following subprocesses
1. Input Image preparation—
   Let x=user photo, m=mask, c=clothing image
   Resize & pad to resolution H×W
      x′=ResizePad(x; H, W), m′=ResizePad(m; H, W), c′=ResizePad(c; H, W)
   Normalize Tensors as
      xₜ=ToTensor(x′), mₜ=ToTensor(m′), cₜ=ToTensor(c′)
2. Masking & Encoding—
   Element wise mask application: x_{masked}=xₜ⊙mₜ
   VAE encoding to Latent: zₘ=E(x_{masked}), z_{c}=E(cₜ), zₘₐₛₖ=E(mₜ)
3. Latent Encoding and Spatial Concatenation—

z_{cond}=Concat(zₘ,z_{c})

Add initial noise ϵ~N(0,I), z_{T}=z_{cond}+ϵ
4. Denoising Loop
   For time steps t=T, T−1, . . . , 1
   UNet noise predictions: (û=ϵ_{θ}(zₜ, t, Ø)), ( [symbol] =ϵ_{θ}(zₜ, t, z_{c}))
   Classifier-free guidance (scale s): \hat{ϵ}= [symbol] +s( [symbol] − [symbol] )
   Scheduler update:

$${z}_{t - 1} = 1 / \sqrt{α} ( {z}_{t} - \frac{1 - {α}_{t}}{\sqrt{1 - {α}_{t}}} \hat{ϵ} )$$

5. Decoding & Safety Checking
   VAE decode (D=decoder): xₒᵤₜ=D(z₀)
   Safety filter:

$${x}_{safe} = \{ \begin{matrix}Safety Checker {x}_{out} \\ {x}_{out}\end{matrix}$$

3D View Engine Network can be subdivided into
1. Geometry Sculpting: Sculpt a coherent, consistent 3D shape that matches a given reference image at one view and remains plausible in unseen views. Some texture is learned here (to match the reference image), but the priority is geometric accuracy and multi-view coherence
2. Texture Enhancement: Refine the object's texture after the geometry is stabilized. Employ a special augmented Score Distillation technique that adaptively learns a scene-specific 2D prior and uses it to guide texture detail and consistency

3D View Engine Geometric Sculpting has subprocesses as
1. Implicit Representation (NeuS et al): The method starts by representing the object's shape with a volumetric radiance field and a signed distance function like NeuS. Second, volume rendering is used to synthesize images from arbitrary viewpoints.
2. Reference View Alignment: A photometric loss ensures the rendered image at the “reference” camera pose matches the input 2D reference image. Then a silhouette or mask constraint (e.g., Lₘₐₛₖ) further aligns foreground regions. Additionally, single-view prior estimates (depth, surface normal) can also be applied: the reference image is passed through depth/normal predictors, and the 3D shape is penalized if it deviates from these depth/normal maps.
3. View Consistency: To ensure plausible shape in unseen views, the engine applies Score Distillation Sampling (SDS) losses from large text-to-image diffusion models (e.g., Stable Diffusion et. al). The resulting gradient then encourages the rendered new views to be recognized as valid samples by the diffusion model. Score Distillation Sampling enforces that rendered images (x) from the 3D representation (g(θ)) should look like valid samples from a pretrained diffusion model (ϵ_{φ}). The gradient on 3D parameters (θ)

$${∇}_{θ} {L}_{SDS} ( ϕ , g ( θ ) ) = {E}_{t , ϵ} [ ω ( t ) ( {ϵ}_{ϕ} ( {x}_{t} ; y , t ) - ϵ ) \frac{\partial θ}{\partial x} ]$$

(x=g(θ)) is the rendered image at a randomly sampled camera viewpoint.
   (xₜ) is the noisy version of (x) at diffusion noise level (t).
   (ϵ) is the random noise added to (x) during the forward diffusion process.
   (y) is the text or other conditioning.
   (ω(t)) is a weighting function depending on (t).
4. 3D-Aware Diffusion Prior: In addition to the general 2D diffusion prior, introduced a specialized “view-conditioned” diffusion model (Zero-1-to-3 et. al), trained on multi-view data. This model, given a single reference image plus a camera viewpoint, predicts what that object should look like from the new view-helping reduce artifacts like “Janus problem” (multiple front-facing features). A hybrid SDS loss is calculated, that blends the general (2D) diffusion prior with the 3D Aware prior for better global consistency
(ϵφ(⋅; \hat{x}, c)) that takes the reference image (\hat{x}) and desired viewpoint (c) as extra inputs.
   The 3D-SDS gradient is:

$${∇}_{θ} {L}_{3 D - SDS} ( ϕ , g ( θ ) ) = {E}_{t , ϵ} [ ω ( t ) ( {ϵ}_{ϕ} ( {x}_{t} ; \hat{x} , c , y , t ) - ϵ ) \frac{\partial x}{\partial θ} ] .$$

The final “hybrid” SDS mixes the standard 2D prior and the 3D-aware prior:

(∇_{θ}L_{hybrid}=∇_{θ}L_{SDS}+μ∇_{θ}L_{3D-SDS})
5. Geometry Refinement via Mesh Conversion: After coarse geometry from (1) to (4) is learned in the implicit representation this refining converts it into a tetrahedral mesh. This allows direct control over the surface for further refining high-frequency geometric features. During this mesh-based stage, they continue to apply the same set of constraints (photometric, mask, SDS) to polish the surface details while also starting to refine the texture.

3D View Engine Texture Enhancement has subprocesses as
1. Leveraging Variational Score Distillation (VSD): To add sharper details, a latent diffusion model (e.g., Stable Diffusion) will be configured. Also Leveraged Variational Score Distillation (VSD), an improved form of SDS that can yield more realistic details. Cons as VSD alone can reintroduce “inconsistency” across different views-since it only sees one image at a time.
2. Augmented Renderings: Added Gaussian noise to the multi-view renderings to produce more diverse training data. The Stable Diffusion model thus learns “3D awareness” of the specific object: it sees multiple viewpoints of the same shape
   This invention of 3D View Engine introduces a finetuned diffusion model (DreamBooth et al) on multiview renderings of the evolving 3D object, then re-distill from this evolving 2D prior. It uses two noise estimators one from a learned LoRA (LoRA et al.) branch (for the rendered view) and One from DreamBooth
   Final Estimation (E) is as follows

$${∇}_{θ} {L}_{BSD} ( ϕ , g ( θ ) ) = {E}_{t , ϵ , c} [ ω ( t ) ( {ϵ}_{DreamBooth} ( {x}_{t} ; y , t , {r}_{t}^{′} ( x ) , c ) - {ϵ}_{lora} ( {x}_{t} ; y , t , x , c ) ) \frac{\partial θ}{\partial x} ]$$

Variables are
   (x): a rendered image from 3D model g(θ)
   (xₜ): that image with added Gaussian noise at diffusion step(t)
   ϵ_{φ}: pretrained noise-prediction network (diffusion model)
   ϵ_{DreamBooth}: the scene-adapted noise-prediction network
   ϵₗₒᵣₐ: a LoRA-based branch for the rendered distribution
   (y): text prompt or textual conditioning
      (c): camera/view parameters
      (\hat{x}): the single reference image
   (\hat{m}, \hat{d}, \hat{n}): referencemask, depth, normal
ω(t): weighting function for SDS or VSD at timestep (t)

The invention can be implemented in digital electronic circuitry, or in computer hardware, firmware, software, or in one or more combinations thereof. The invention can be implemented in a computer program product tangibly embodied in a machine-readable storage device for execution by a programmable processor; and method steps in the invention can be performed by a programmable processor execution a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive instructions and data from a read-only memory and/or a random-access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and optical disks. Any of the foregoing can be supplemented by, or incorporated in, ASICs (application-specific integrated circuits).

A computer system as contemplated herein can include a bus, a processor, a system memory, a read-only memory, a permanent storage device, input devices, and output devices. In some embodiments, the computer system also includes a graphic processing unit (GPU). The bus collectively represents all system, peripheral, and chipset buses that support communication among internal devices of the computer system. For instance, the bus communicatively connects the processor with read-only memory, system memory, and a permanent storage device.

From these various memory units, the processor (also referred to as a central processing unit or CPU) retrieves instructions to execute and data to process in order to execute the processes of the invention. Read-only-memory (ROM) stores static data and instructions that are needed by the processor and other modules of the computer system.

A permanent storage device is a read-and-write memory device. This device is a non-volatile memory unit that stores instruction and data even when the computer system is off. Some embodiments of the invention use a mass-storage device (such as a magnetic or optical disk and its corresponding disk drive) as a permanent storage device. The permanent storage device may be a solid-state storage, a conventional “spinning magnetic pallet” storage (i.e., hard drive), or combinations thereof. Other embodiments may use a removable storage device (such as a USB flash drive or SD Memory Card) as a temporary storage or as the permanent storage device.

System memory is a read and write memory device. The system memory can be a volatile read-and-write memory, such as a random-access memory. The system memory stores at least some of the instructions and data that the processor needs at runtime.

Instructions and/or data needed to perform processes of some embodiments are stored in the system memory, the permanent storage device, the read-only memory, or any combination. For example, the various memory units may contain instructions for processing multimedia items in accordance with some embodiments. From these various memory units, the processor retrieves instructions to execute and data to process in order to execute the processes of some embodiments.

The bus also connects to input and output devices. The input devices enable the user to communicate information and select commands to the computer system. The input devices include, but are not limited to, alphanumeric keyboards, touch panels, cursor controllers and voice command or instruction input. Voice input can include voice commands or instructions input through artificial intelligence (AI) and AI agents and the like. The input devices also include scanners through which an image can be input to the computer system. The output devices display images generated by the computer system. The output devices may include display devices including touch display, such as liquid crystal displays (LCD), light emitting diode (LED), organic light emitting diode (OLED), active matrix organic light emitting diode (AMOLED), electroluminescent displays, cathode ray tubes (CRT), as well as printers, pen plotters, laser printers, ink-jet plotters, and film recorders. More specifically, this includes output displays including state-of-the-art displays and touch displays on cell phones, tablets, laptops and notebook computers, and desktop computers.

Bus can also couple a computer to a network through a network adapter. In this manner, the computer can be a part of a network of computers (such as a local area network (“LAN”), a wide area network (“WAN”), or an Intranet) or a network of networks (such as the Internet). Finally, the computer system in some embodiments also optionally includes a graphics processing unit (GPU). A GPU (also referred to as a visual processing unit or a display processor) is a dedicated graphics rendering device which is very efficient in manipulating and displaying computer graphics. The GPU can be included in a video card or can be integrated into the mother board of the computer system along with the processor. Any or all the components of computer system may be used in conjunction with the invention. However, one of ordinary skill in the art will appreciate that other system configurations may also be used in conjunction with the invention.

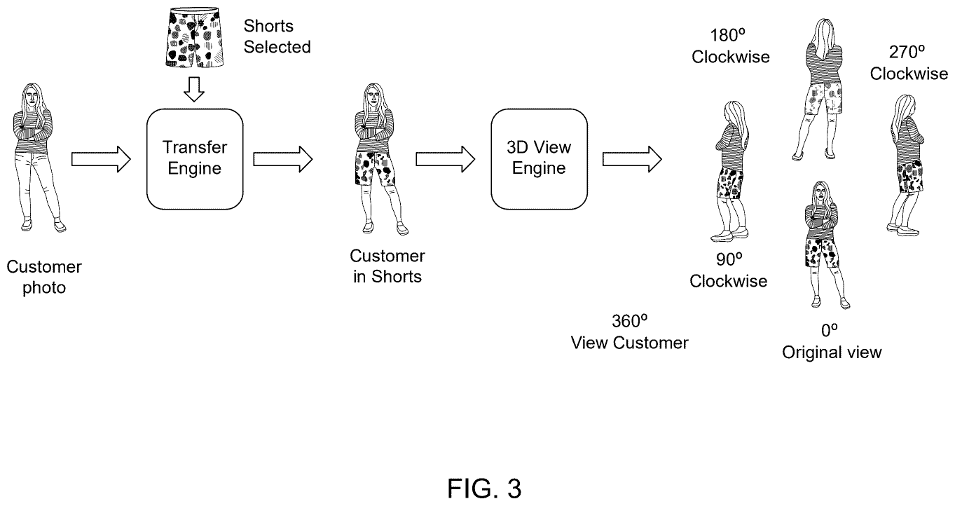

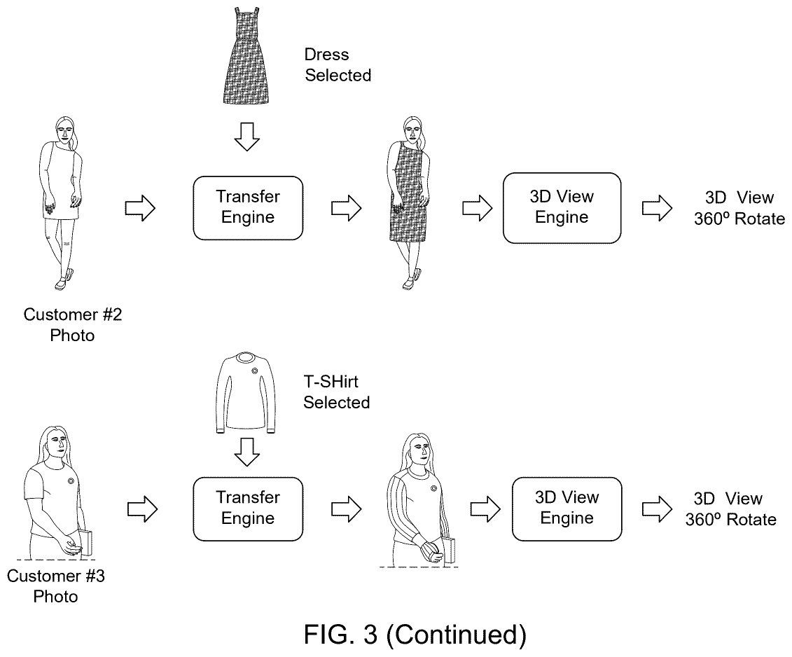

FIG. 3 shows another exemplary process of the invention. In FIG. 3, a customer photo is provided and shorts selected which are input to the transfer engine. The transfer engine outputs the customer wearing the selected shorts, which is an input to the 3D view engine. The 3D view engine outputs a full 360° view of the customer wearing the selected shorts. FIG. 3 (continued) shows two additional exemplary embodiments of the process showing a dress selection and a T-shirt selection.

### GLOSSARY

U-Net is a convolutional neural network that was developed for image segmentation. The network is based on a fully convolutional neural network whose architecture was modified and extended to work with fewer training images and to yield more precise segmentation. The U-Net architecture has also been employed in diffusion models for iterative image denoising.

In machine learning, a variational autoencoder (VAE) is an artificial neural network architecture and is part of the families of probabilistic graphical models and variational Bayesian methods. In addition to being seen as an autoencoder neural network architecture, variational autoencoders can also be studied within the mathematical formulation of variational Bayesian methods, connecting a neural encoder network to its decoder through a probabilistic latent space (for example, as a multivariate Gaussian distribution) that corresponds to the parameters of a variational distribution.
LoRA: Low-Rank Adaptation of LLM
DreamBooth: Fine tuning text-to-image diffusion models for subject-driven generation
NeuS: Learning Neural Implicit Surfaces by Volume Rendering for Multi-view Reconstruction
SDS: Scored Distillation Sampling
LDM: Latent Diffusion Model
PIL: Python Image Library

A computer or device, as used herein, generally refers to a smartphone, a tablet computer, a desktop computer, a smart watch or other wearable, or the like. A notebook computer is used in its ordinary sense and includes laptop computers and other portable computing devices. A desktop computer is also used in its ordinary sense and includes standard desktop computing devices.

A computer display refers to a display screen of any one of the above devices. As used herein, this term refers to any and all computer display screens including touch screens in current use on any of the mentioned devices.

An article of clothing or clothing or cloth as used herein refers to any clothes, garments, dress, apparel, or attire, or the like that is worn on a subject or human body. This can include but is not limited to hats, shirts, tops, pants, socks, suits, dresses, one piece dresses and suits, and the like. Basically, any clothing item sold online by an online clothes retailer or department store. Typically, clothing is made of fabrics or textiles, but can be made from animal skin and other thin sheets of man-made materials and natural products.

A subject as used herein, generally refers to humans, however, can also refer to animals including pets.

Providing or selecting an image normally refers to selecting an article of clothing from an e-commerce platform, e.g., an online clothes retailer, department store, or any other on-line site that sells clothing. Uploading an image of an article of clothing onto the computer is also possible.

Providing an image of a subject can refer to uploading an image of a subject onto a computer or it can be an image already present on the computer, or can be taken from a social media site, another website, an ecommerce platform, or the like. Essentially, the image can be taken from any source on a computer including smartphone, tablet, laptop, desktop, or from the Internet.

A first article of clothing as used herein refers to any article of clothing. An article of clothing that is not the first article of clothing is thus understood as being an article of clothing that is different from the articles of clothing worn by the subject in the input image provided by the subject.

The three-dimensional image showing the subject wearing the selected article of clothing can show the article of clothing correctly fit onto the subject. That is, the 2D and 3D image can show the article of clothing properly sized and fitted on the subject.

While this disclosure includes specific examples, it will be apparent after an understanding of the disclosure of this application has been attained that various changes in form and details may be made in these examples without departing from the spirit and scope of the claims and their equivalents.

1. A method of rendering an image on a computer display, of a subject wearing an article of clothing comprising:
providing or selecting an image of a first article of clothing on the computer;
providing an image on the computer of the subject wearing one or more articles of clothing, that do not include the first article of clothing;
inputting the image of the first article of clothing and the provided image of the subject wearing the one or more articles of clothing to an artificial intelligence (AI) transfer engine;
outputting from the artificial intelligence transfer engine a 2 dimensional (2D) image of the person wearing the first article of clothing;
inputting the two-dimensional image of the subject wearing the first article of clothing into an 360 degree 3 dimensional (3D) view engine;
outputting from the 360 degree 3 dimensional (3D) view engine a 360 degree 3 dimensional view of the subject wearing the first article of clothing.

2. The method of claim 1, wherein the artificial intelligence transfer engine comprises the steps of: masking and encoding, concatenating condition and noise, and a denoising loop.

3. The method of claim 2, wherein the artificial intelligence transfer engine comprises the additional steps of: initialization and decoding and safety check.

4. The method of claim 1, wherein the 360 degree 3 dimensional (3D) view engine includes the steps: geometry sculpting, augmenting texture, and providing 3 dimensional consistency hints.

5. The method of claim 1, wherein the artificial intelligence transfer engine includes the convolutional neural network, U-Net.

6. The method of claim 1, wherein the artificial intelligence transfer engine includes a variational autoencoder.

7. The method of claim 1, wherein the 360 degree 3 dimensional view of the subject wearing the first article of clothing, shows the article of clothing properly sized and/or fitted for the subject.
